(19) United States
(12) Patent Application Publication
(10) Pub. No.: US 2013/0218617 A1
(43) Pub. Date: Aug. 22, 2013

(54) APPARATUS AND METHOD FOR DELIVERY OF ORG MODEL AND BEST PRACTICES

(71) Applicant: Reiner Wallmeier, Wiesloch (DE)

(72) Inventor: Reiner Wallmeier, Wiesloch (DE)

(73) Assignee: SAP AG, Walldorf (DE)

(21) Appl. No.: 13/402,433

(22) Filed: Feb. 22, 2012

(51) Int. Cl. G06Q 10/06

(52) U.S. Cl. 705/7.12

(57) ABSTRACT

An apparatus, method and computer-readable storage medium to efficiently create and model ERP representations of an organization (ORG). Predefined ERP entities may be presented to a user. The user may instantiate (or create) one or more of the presented entities. The user may be presented with predefined dimension types and available dimension values for the instantiated entity. The user may select/assign values to the dimension types, and as a result, the available values for other dimension types of one or more instantiated entities may decrease.

### BACKGROUND

Traditional Enterprise Resource Planning (ERP) software provides users with generic versions of entities such as vendor, customer, product/service, contract, and management structure. A user can utilize the provided generic entities to build ERP models i.e., ERP representations of organizations (ORGs). A major problem of traditional ERP software is that the user of the traditional software has to invest significant amounts of labor, money, and time to customize the pre-packaged generic entities to simulate a real-world organization. Specifically, the user has to define various attributes for every entity, define the relationships between the entities, and define the business rules pertaining to the entity relationships.

### BRIEF DESCRIPTION OF THE DRAWINGS

FIG. 1 illustrates an exemplary representation of internal and external management information across an organization (ORG) in an embodiment.

FIG. 2 illustrates classifying entities and the relationships between the entities in an ERP system based on dimensions in an embodiment.

FIG. 3 illustrates the association between business rules and entities in an organization (ORG) in an embodiment.

FIG. 4 illustrates exemplary ERP criteria built into software in an embodiment.

FIGS. 5(a) and 5(b) illustrate modification of software based on the type of user in an embodiment.

FIG. 6 shows an exemplary architecture in an embodiment.

### DETAILED DESCRIPTION

Embodiments may be discussed in systems and processes to efficiently create and model ERP representations of an organization (ORG). In particular, embodiments of the present invention pertain to a feature for presenting predefined ERP entities to a user via software. The user may instantiate (or create) one or more of the presented entities. The software may present the user with predefined dimension types and available dimension values for the instantiated entity. The user may select/assign values to the dimension types, and as a result, the available values for other dimension types of one or more instantiated entities may decrease.

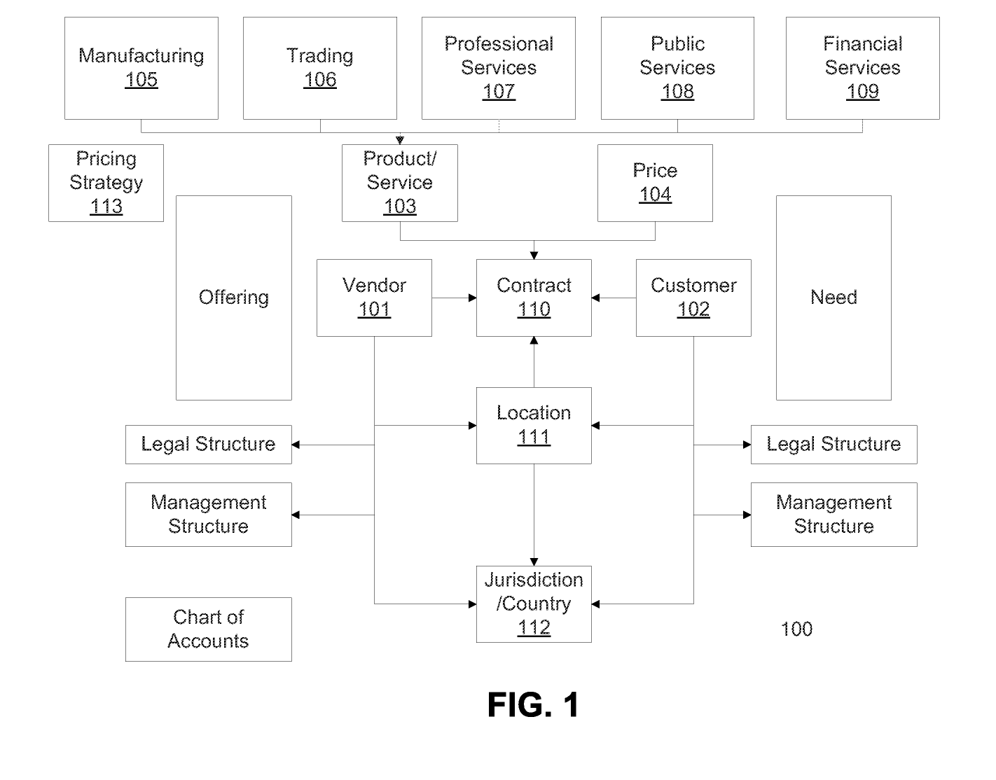

FIG. 1 illustrates an exemplary representation of internal and external management information across an organization 100 in an embodiment of the present invention. The organization (ORG) 100 may include a vendor 101 offering a product or a service 103 at a particular price 104. Based on the type of product/service 103 provided and the market for the product/service 103, the vendor 101 may have a particular pricing strategy 113 to calculate the price 104. The product/service may be related to industries such as manufacturing 105, trading 106, professional services 107, public services 108, and financial services 109. The product/service may be purchased by the customer 102 from the vendor 101 through one or more contracts 110, which may be governed by the laws of a particular country or jurisdiction 112. The contract(s) 110 may specify that the product/service is to be provided/delivered at a predetermined location 111. Both the vendor 101 and customer 102 may be organizations with their own legal and management structures. In an embodiment, the internal and external management information across an organization may be integrated by an enterprise resource planning (ERP) system. ERP systems may automate activity across an organization through ERP software.

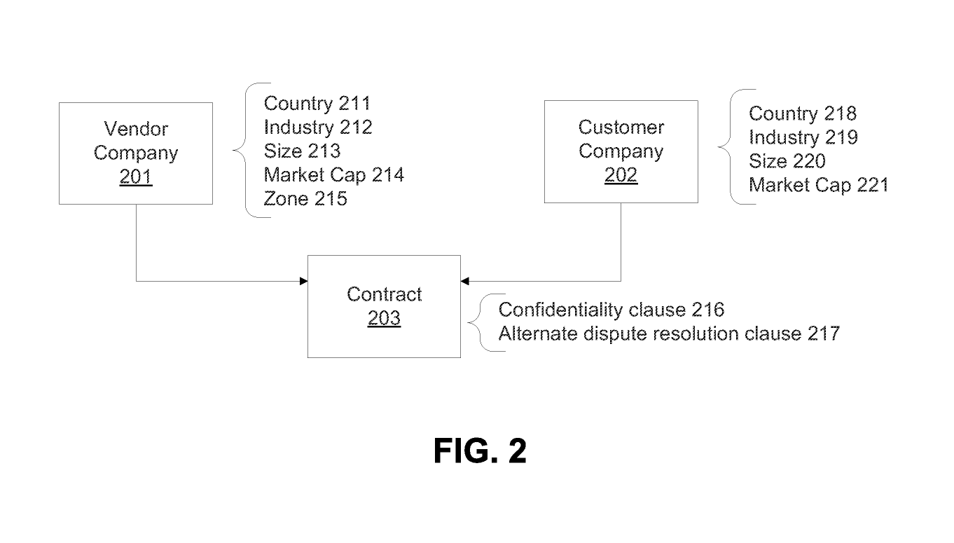

FIG. 2 illustrates classifying entities and the relationships between the entities in an ERP system based on dimension types (dimensions) in an embodiment of the present invention. An entity from an organization (ORG), such as the organization shown in FIG. 1, may be classified based on various dimensions. For example, in an embodiment, a vendor company 201 may be classified based the country 211 where the vendor company is incorporated, the industry 212 in which the vendor company operates, the size 213 (based on the number of employees) of the company, the market capitalization 214 of the vendor company, and the zone 215 where the company may be located.

In an embodiment, certain dimensions of the entity may affect the possible values which can be assigned to other dimensions of the entity. In an exemplary embodiment, vendor company 201, may be assigned a value of “Germany” for the dimension country 211, and “pharmaceutical industry” for the dimension industry 212. Germany may have laws which restrict the number of employees and market capitalization of pharmaceutical companies, and thus, the possible values which can be assigned to the entity, vendor company 201, for dimensions size 213 and market capitalization 214 may be limited to a particular range.

In an embodiment, the values assigned to a first set of dimensions of an entity may restrict the values which may be assigned to a second set of dimensions of that entity to such a degree that the second set of dimensions may have to be assigned a single default value. For example, in an embodiment, the vendor company 201, may be a pesticide manufacturer (dimension 212) in the United States (dimension 211) which produces toxic fumes in the process of manufacturing the pesticide. As a result, laws may prohibit the company from being located anywhere but an industrial zone (dimension 215).

In an embodiment, values assigned to dimensions of one or more entities may affect the values which may be assigned to the dimensions of another entity. For example, the dimensions of a contract 203 between the vendor company 201 and the customer company 202 may be affected by the dimensions of the vendor company 201. In an embodiment, the vendor company 201 may be a bank (dimension 212) incorporated in Switzerland (dimension 211). Since the vendor company 201 is a Swiss bank, the confidentiality clause (dimension 216) of the contract entity 203 may mandate that the Swiss bank cannot disclose any information about the account in response to a request by a third party, unless very specific criteria are met by the request. On the contrary, if dimension 211 is United States, i.e., the vendor company 201 is an American bank, the confidentiality clause (dimension 216) may not be as rigid as a Swiss bank's confidentiality clause.

In a further embodiment, the relationship between one or more entities may affect the values which may be assigned to the dimensions of another entity. For example, the dimensions of a contract 203 between the vendor company 201 and the customer company 202 may be affected by the relationship between the vendor company 201 and the customer company 202. In an embodiment, the vendor company 201 may be a car manufacturer (dimension 212) incorporated in India (dimension 211). The customer company 202 may be a car retailer (dimension 219) also incorporated in India (dimension 219). In India, a best practice (or common practice) may exist in the car industry to settle disputes between car manufacturers and car retailers through arbitration (a form of alternate dispute resolution). Therefore, the contract 203 may specify mandatory arbitration as part of the alternate dispute resolution clause (dimension 217).

In an embodiment, values assigned to dimensions of one or more entities may affect the existence of one or more other entities. For example, the existence of a contract 203 may depend on the dimensions of the vendor company 201 and the customer company 202. In an embodiment, the vendor company 201 may be incorporated in country A (dimension 211). Customer company 202 may be incorporated in country B (dimension 218). There may be an embargo imposed on country B by country A, and thus laws in country A may prohibit business transactions between country A and country B. Consequently, there may be no legal contract 203 between vendor company 201 and customer company 202.

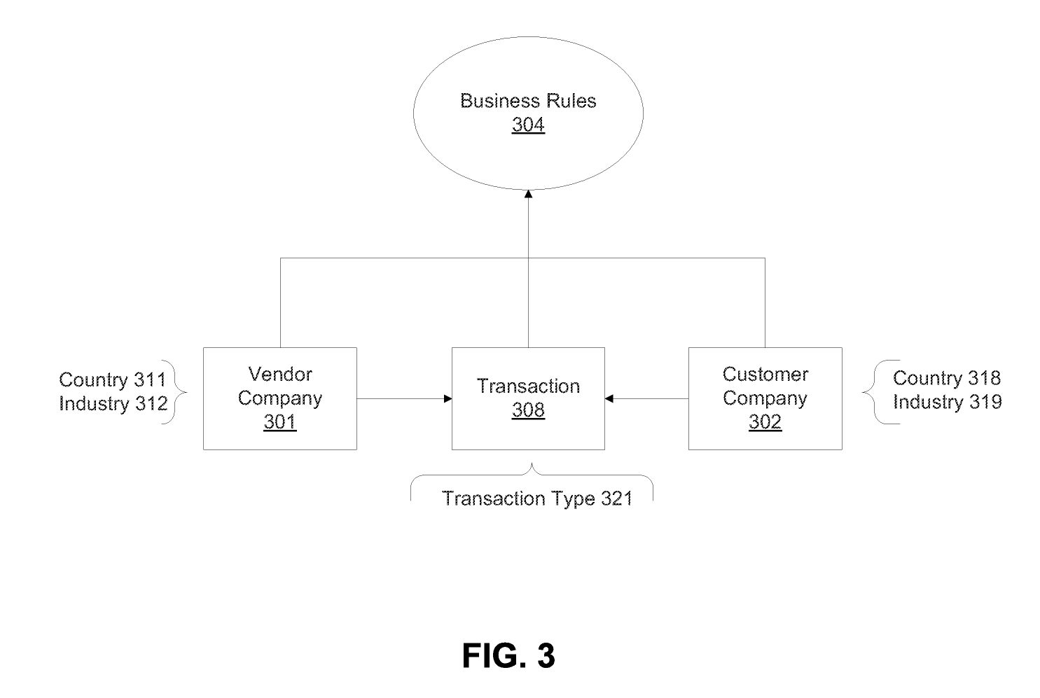

FIG. 3 illustrates the association between business rules and entities in an organization (ORG) in an embodiment of the invention. In an embodiment, business rules may be dependent on dimensions of entities and the relationships between entities. An organization, such the organization from FIG. 1, may contain various entities including a vendor company 301, a customer company 302, and the transaction(s) 308 between the vendor company 301 and customer company 301. The vendor company 301 may be a French (dimension 311) winery (dimension 312). The customer company may be an American (dimension 318) wine store (dimension 319). The transaction entity 308 may include a transaction type dimension 321. In an exemplary embodiment, the possible values for the transaction type dimension 321 may be “bulk transaction” or “regular transaction.” The difference between a bulk transaction and a regular transaction may depend on the number of bottles of wines sold. The best practice (or the typical practice) in the French winery industry, when dealing with an American wine store may be to require payment within 2 weeks if the transaction type 321 is a regular transaction, and within a month after the sale if the transaction type 321 is a bulk transaction. The best practice in the French winery industry, may be to send payment reminders one week prior to the payment due date. Such payment reminders may be represented as business rules 304 in an ERP system. Therefore the business rules 304 are dependent on the dimensions of the entities and the relationships between the entities.

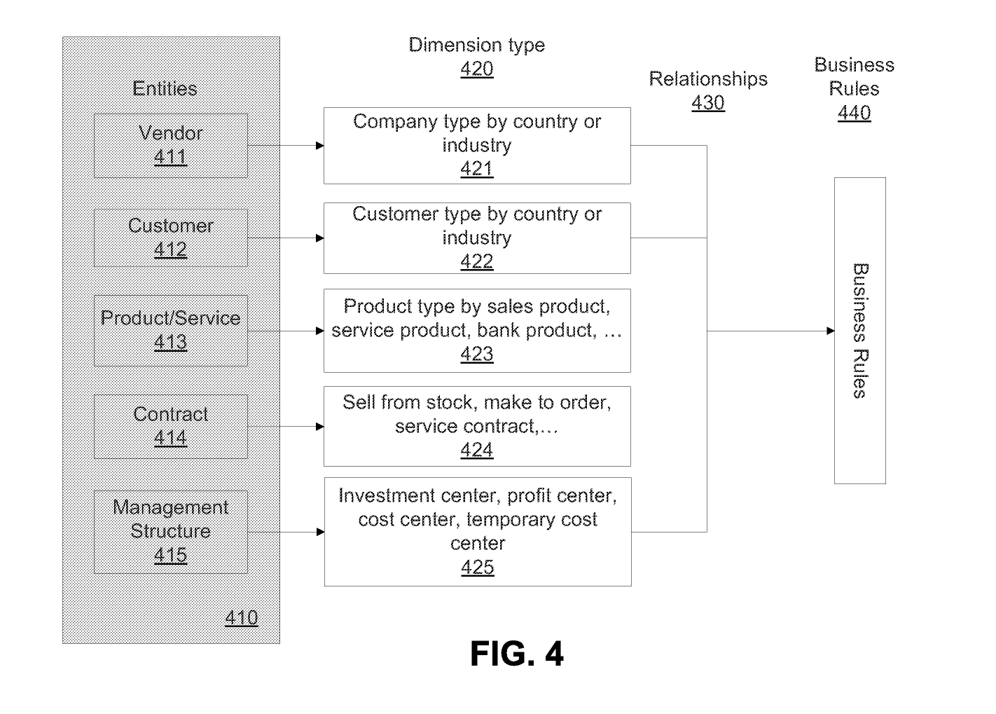

FIG. 4 illustrates exemplary ERP criteria built into software in an embodiment of the present invention. The shaded region 410 illustrates entities of an organization (ORG) available through traditional ERP modeling software. Traditional ERP software included a bare bones version of entities such as vendor 411, customer 412, product/service 413, contract 414, and management structure 415. A major problem of traditional ERP software was that the user of the traditional software had to invest significant amounts of labor, money, and time to customize the pre-packaged generic entities to simulate a real-world organization. Specifically, the user had to define various attributes for every entity, define the relationships between the entities, and define the business rules pertaining to the entity relationships. For example, the user of the traditional software may be a coffee supplier. The coffee supplier may want to build a model of its organization (ORG) utilizing the traditional software. However, in order to do so, the coffee supplier may first have to define the entity, vendor 411, as a coffee supplier, and include specifics about the vendor 411 such as the size of the coffee supplier, the location of the coffee supplier, the industrial zone in which the coffee supplier is located, the locations to which the coffee supplier can ship its products, etc. The user of the traditional software may have to do the same for all the other generic entities, i.e., entities 412-415. Consequently, the user has to expend significant start-up costs and effort to utilize the traditional ERP software.

In an embodiment, 1) the various entities of an organization (ORG), 2) the different possible dimensions and dimension values of the various entities, 3) the various business rules associated with the entities and entity relationships, and 4) the constraints imposed by dimensions of entities and relationships between entities as described in the aforementioned exemplary embodiments may be built into computer software. Therefore, a user of the software does not need to build ERP representations of one or more organizations from scratch, but can instead utilize the predefined information from the software.

In an embodiment, the software may allow the user to easily define attributes of an entity by presenting the user with a set of dimension types 420 pertaining to the entity. For example, the software may present the user with dimensions country and industry 421 pertaining to a vendor entity 411 upon instantiation of the vendor entity 411 via the software. In an embodiment, the software may present the user with predefined values for the dimensions. For example, the country dimension for vendor 411 may include values such as Germany, France, India, United States, and Canada. The industry dimension may include values such as insurance, wine, coffee, automotive, and computer. In an embodiment, some dimensions may include sub-dimensions. For example, the computer industry dimension value may include sub-dimension values such as software and hardware. The sub-dimensions may then other sub-dimensions accordingly based on the granularity needed.

In an embodiment, if certain values for one or more dimensions of an entity are selected via the software, the available value ranges for other dimensions for that entity may decrease. For example, if the user sets the value of the industry dimension of vendor 411 as coffee, then the possible values for the country dimension of vendor 411 may decrease since some countries may not have any vendors that sell coffee. In an embodiment, if certain values for one or more dimensions of an entity are selected via the software, values may be assigned automatically to other dimensions of the entity. For example, if the user sets the value of the industry dimension of vendor 411 as cement, and the country dimension of vendor 411 as country A, a zone dimension of vendor 411 may automatically default to industrial since country A may have regulations requiring cement vendors to be located in a particular zone (i.e., industrial zone in this example).

In an embodiment, relationships 430 between entities and/or dimensions may be predefined in the software. For example, upon creation (instantiation) of a vendor 411 in the coffee industry, the software may automatically suggest or link the coffee industry vendor entity with an existing coffee industry customer entity. In an embodiment, if there are no existing customer entities, the software may automatically create a customer 412 in the coffee industry, and establish a relationship between the vendor 411 in the coffee industry and the customer 412 in the coffee industry.

In an embodiment, the software may restrict the creation or modification of relationships between entities based on the values of particular dimensions of the entities. In an embodiment, the software may only allow the user to create relationships between entities with compatible dimension values. For example, there may be three existing entities. The first entity may be a vendor 411 in the car industry, the second entity may be a vendor 411 in the wine industry, and the third entity may be a customer 412 in the car industry. The software may therefore only allow a relationship between the first entity and the third entity since the industries of the first and third entities are compatible.

In an embodiment, if certain values for one or more dimensions of a first entity are selected via the software, the available value ranges for other dimensions of a second entity related to the first entity may decrease. In an embodiment, if certain values for one or more dimensions of a first entity are selected via the software, values may be assigned automatically to dimensions of a second entity related to the first entity. For example, country A's automotive industry vendors may only specialize in hybrid cars. Thus, if the user sets the value of the industry dimension of vendor 411 as automotive, and the value of the country dimension of vendor 411 as country A, the product type dimension pertaining to the product/service entity 413 may be automatically set to hybrid car.

In an embodiment, business rules 440 based on relationships 430 between entities and/or dimensions may be predefined in the software. For example, an user may create a vendor 411 with an industry dimension of computer hardware, and a country dimension of Japan. The user may create a customer 412 with an industry dimension of computer hardware and a country dimension of United States. The user may establish a relationship between the vendor 411 and the customer 412. The computer software may then automatically, or based on input from the user, generate business rules pertaining to the created entities and the relationship between the entities. For example, the software may generate rules for reminders (dunning) for payment of goods sold to the computer hardware customer. In an embodiment, the generated rules may be created from rules which are already predefined in the software. The software may be preloaded with all rules pertaining to different possible combinations of entity dimensions and relationships between entities/dimensions. The rules predefined in the software may mirror best business practices or customary business practices in various industries.

In an embodiment, although the software may initially contain predefined information about entities, dimensions, relationships, and business rules as described above, the user of the software may modify the predefined information in the software to fit the needs of the user. In an embodiment, the user may use a combination of the predefined information in the software and information modified/added by the user.

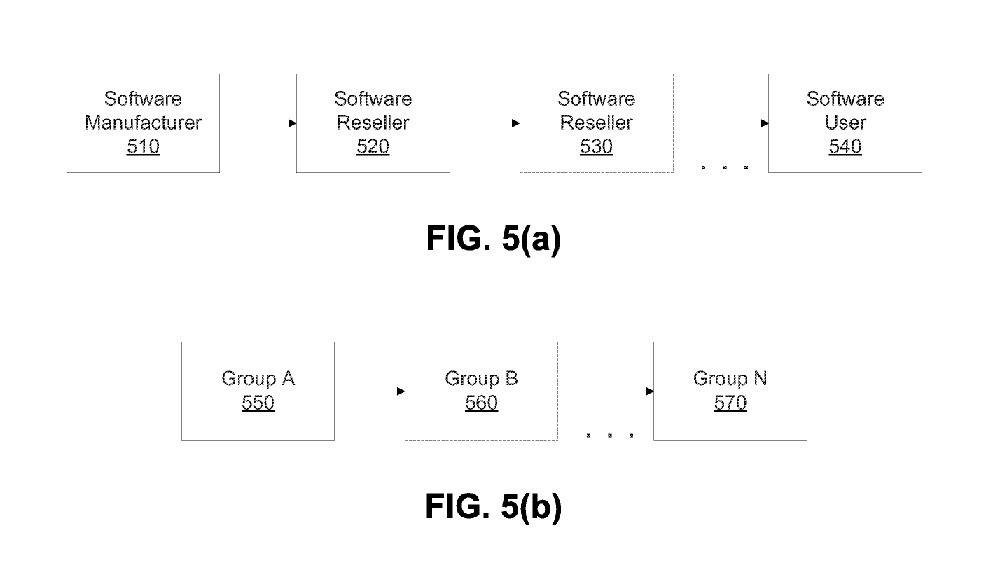

FIGS. 5(a) and 5(b) illustrate modification of software based on the type of user in an embodiment of the invention. In an embodiment, the manufacturer of the software may be one of many sellers of the software. Software manufacturer 510 may sell the software to software reseller 520. Software reseller 520 may then sell the software to another software reseller 530, and so on. The software may ultimately be sold to a software user 540. The software manufacturer 510 may tailor the software to the needs of software reseller 520 by creating the software with entities, dimensions, relationships, and business rules pertinent to software reseller 520. Software reseller 520 may then modify the predefined information in the software to tailor it to software reseller 530, or to a software user 540.

For example, in an embodiment, software manufacturer 510 may be the company SAP which creates the software. Software reseller 520 may be a software distributor such as IBM. SAP 510 may sell the software to IBM 520, and IBM 520 may then sell the software to an end user of the software 540, a small local Indian bank which only engages in business in India. SAP 510 may tailor the software so that it only includes the information relevant to the possible clients of IBM 520. The clients of IBM 520 may be from 50 countries in the world. Therefore, SAP may tailor the software to include entities, dimensions, relationships, and business rules only relevant to those 50 countries. However, prior to selling the software to the bank in India 540, IBM 520 may remove any information pertaining to countries other than India. In an embodiment, IBM 520 may include additional information to the software to accurately reflect entities, dimensions, relationships, and business rules relevant to the organization of small local Indian bank, and/or best practices (or common practices) in the Indian banking industry. The local Indian bank 540 may then use the software as shipped from IBM 520, or modify the information in the software as needed. In an embodiment, there may be one or more resellers such as software reseller 530 between IBM 520 and the local Indian bank 540.

In an embodiment, the software deployment described in the context FIG. 5(a) may be adjusted to a different granularity. For example, an analogous method of software deployment may be used internally within a company as illustrated in FIG. 5(b). In an embodiment, a first group 550 within a company may initially create the software and/or receive the software from another company (for example, a software manufacturer or software reseller as described in FIG. 5(a)). Group 550 may then tailor the software based on the needs of a group 560. This process may be repeated as needed within the company until the software is deployed to the ultimate software user, group 570.

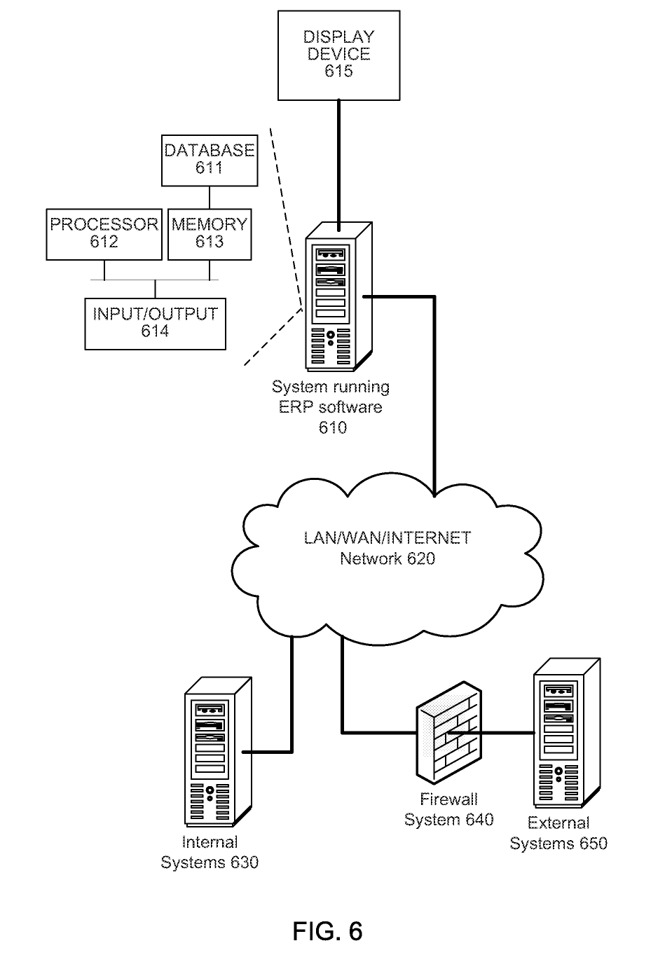

FIG. 6 shows an exemplary architecture in an embodiment of the invention. The system running an application to view, create, or modify ERP models 610 may be coupled to a display device 615, existing internal systems 630 through a network 620 and to external systems 650 through the network 620 and firewall system 640. The system running an application to view, create, or modify ERP models 610 may include a desktop computer, laptop computer, tablet PC, client computer, mobile phone, central computer in a vehicle, and any other computer. The display device 615 may include a computer monitor, a tablet PC screen, a mobile phone screen, and any other displays. The existing internal systems 630 may include a server and may provide one or more of entity data, dimension type data, dimension value data, relationship data, and other data. The external systems 650 may include a server and may be maintained by a third party, such as an information service provider, and may contain entity data, dimension type data, dimension value data, relationship data, and other data, that may be updated by the third party on a periodic basis. The system running an application to view, create, or modify ERP models 610 may interact with these external systems to obtain updates through a firewall system 640 separating the internal systems from the external systems.

A person having ordinary skill in the art will appreciate that while internal systems 630 and external systems 650 are included in FIG. 6, in some embodiments, one or both of these systems may not be required. In an embodiment, the functionality provided by the internal systems 630 and external systems 650 may be provided by the system running the ERP software 610.

Each of the systems in FIG. 6 may contain a processing device 612, memory 613, a database 611, and an input/output interface 614, all of which may be interconnected via a system bus. In various embodiments, each of the systems 610, 630, 640, and 650 may have an architecture with modular hardware and/or software systems that include additional and/or different systems communicating through one or more networks. The modular design may enable a business to add, exchange, and upgrade systems, including using systems from different vendors in some embodiments. Because of the highly customized nature of these systems, different embodiments may have different types, quantities, and configurations of systems depending on the environment and organizational demands.

In an embodiment, memory 613 may contain different components for retrieving, presenting, changing, and saving data. Memory 613 may include a variety of memory devices, for example, Dynamic Random Access Memory (DRAM), Static RAM (SRAM), flash memory, cache memory, and other memory devices. Additionally, for example, memory 613 and processing device(s) 612 may be distributed across several different computers that collectively comprise a system.

Database 611 may include any type of data storage adapted to searching and retrieval. The database 611 may include SAP database (SAP DB), Informix, Oracle, DB2, Sybase, and other such database systems.

Processing device 612 may perform computation and control functions of a system and comprises a suitable central processing unit (CPU). Processing device 612 may comprise a single integrated circuit, such as a microprocessing device, or may comprise any suitable number of integrated circuit devices and/or circuit boards working in cooperation to accomplish the functions of a processing device. Processing device 612 may execute computer programs, such as object-oriented computer programs, within memory 613.

In an embodiment, the ERP software may be used within an on-premise business model, an on-demand business model, or a combination of the two. In an on-premise business model, the ERP software application is housed in-house by a company and the company owns/controls the servers, connections, entitlements, and data pertaining to the ERP software. In an on-demand business model, the servers, connections, entitlements, and data pertaining to the ERP software are owned and controlled by a third-party (such as the ERP software vendor).

In an embodiment, one or more components of the ERP software may be delivered to the end user via cloud computing (private and/or public). The one or more components of the ERP software may be stored on servers at a remote location and delivered over a network. In a public cloud, the provider of the ERP software may deliver the software and/or the data of the software over the Internet. On the other hand, in a private cloud, the cloud is operated exclusively for the end user of the software. The private cloud may be managed by the end user or a third-party, and may be hosted internally or externally.

The foregoing description has been presented for purposes of illustration and description. It is not exhaustive and does not limit embodiments of the invention to the precise forms disclosed. Modifications and variations are possible in light of the above teachings or may be acquired from the practicing embodiments consistent with the invention. For example, some of the described embodiments may include software and hardware, but some systems and methods consistent with the present invention may be implemented in software or hardware alone. Additionally, although aspects of the present invention are described as being stored in memory, this may include other computer readable media, such as secondary storage devices, for example, solid state drives, or DVD ROM; the Internet or other propagation medium; or other forms of RAM or ROM.

1. A computer-implemented method for creating an Enterprise Resource Planning representation of an organization comprising:
presenting, by a computer processor, a predefined plurality of available Enterprise Resource Planning entities;
upon creating an instance of an entity from the plurality of available Enterprise Resource Planning entities, presenting a plurality of predefined dimension types for the created entity instance;
presenting a predefined plurality of available values for each dimension type of the plurality of dimension types; and
in response to selecting, by a user, a value for at least one dimension type of the plurality of dimension types, decreasing the selectable values for at least another dimension type presented to the user and associated with the entity instance, wherein the selectable values of the at least another dimension type are dependent on the selected value of the at least one dimension type.

2. The method of claim 1, further comprising:
presenting a predefined plurality of available relationships between created instances of entities;
upon creating an instance of a relationship from the plurality of available relationships, presenting at least one predefined business rule associated with the relationship instance.

3. The method of claim 1, further comprising:
upon determining that decreasing the selectable values for the at least another dimension type results in a single selectable value, automatically selecting the single selectable value.

4. The method of claim 2, wherein creating the instance of the relationship decreases available values for at least a dimension type of at least an entity associated with the relationship instance.

5. The method of claim 2, wherein the plurality of available relationships between entity instances depends on at least one selected dimension value of at least one entity instance.

6. The method of claim 2, wherein at least one of: a) the predefined plurality of dimension types, b) the predefined plurality of available values for each dimension type, c) the predefined plurality of available relationships and d) the at least one predefined business rule is predefined based on best business practices.

7. A non-transitory computer-readable medium embodied with computer-executable instructions for causing a computer to execute instructions, the computer instructions comprising:
presenting, by a computer processor, a predefined plurality of available Enterprise Resource Planning entities;
upon creating an instance of an entity from the plurality of available Enterprise Resource Planning entities, presenting a plurality of predefined dimension types for the created entity instance;
presenting a predefined plurality of available values for each dimension type of the plurality of dimension types; and
in response to selecting, by a user, a value for at least one dimension type of the plurality of dimension types, decreasing the selectable values for at least another dimension type presented to the user and associated with the entity instance, wherein the selectable values of the at least another dimension type are dependent on the selected value of the at least one dimension type.

8. The computer-readable medium of claim 7, wherein the computer instructions further comprising:
presenting a predefined plurality of available relationships between created instances of entities;
upon creating an instance of a relationship from the plurality of available relationships, presenting at least one predefined business rule associated with the relationship instance.

9. The computer-readable medium of claim 7, wherein the computer instructions further comprising:
upon determining that decreasing the selectable values for the at least another dimension type results in a single selectable value, automatically selecting the single selectable value.

10. The computer-readable medium of claim 8, wherein creating the instance of the relationship decreases available values for at least a dimension type of at least an entity associated with the relationship instance.

11. The computer-readable medium of claim 8, wherein the plurality of available relationships between entity instances depends on at least one selected dimension value of at least one entity instance.

12. The computer-readable medium of claim 8, wherein at least one of: a) the predefined plurality of dimension types, b) the predefined plurality of available values for each dimension type, c) the predefined plurality of available relationships and d) the at least one predefined business rule is predefined based on best business practices.

13. An apparatus comprising:
a processor for executing computer instructions, the processor configured to:
present a predefined plurality of available Enterprise Resource Planning entities;
upon creation of an instance of an entity from the plurality of available Enterprise Resource Planning entities, present a plurality of predefined dimension types for the created entity instance;
present a predefined plurality of available values for each dimension type of the plurality of dimension types; and
in response to selection, by a user, of a value for at least one dimension type of the plurality of dimension types, decrease the selectable values for at least another dimension type presented to the user and associated with the entity instance, wherein the selectable values of the at least another dimension type are dependent on the selected value of the at least one dimension type.

14. The apparatus of claim 13, wherein the processor is further configured to:
present a predefined plurality of available relationships between created instances of entities;
upon creation of an instance of a relationship from the plurality of available relationships, present at least one predefined business rule associated with the relationship instance.

15. The apparatus of claim 13, wherein the processor is further configured to:
upon determination that decreasing the selectable values for the at least another dimension type results in a single selectable value, automatically select the single selectable value.

16. The apparatus of claim 14, wherein upon the creation of the relationship instance, the processor is configured to decrease available values for at least a dimension type of at least an entity associated with the relationship instance.

17. The apparatus of claim 14, wherein the plurality of available relationships between entity instances depends on at least one selected dimension value of at least one entity instance.

18. The apparatus of claim 14, wherein at least one of: a) the predefined plurality of dimension types, b) the predefined plurality of available values for each dimension type, c) the predefined plurality of available relationships and d) the at least one predefined business rule is predefined based on best business practices.
